(19) United States
(12) Patent Application Publication
(10) Pub. No.: US 2025/0338254 A1
(43) Pub. Date: Oct. 30, 2025

(54) ENHANCED PAGING EARLY INDICATION (PEI) MESSAGING FOR USER EQUIPMENT: FEATURE LIST MAPPING FOR PAGING OCCASIONS

(71) Applicant: QUALCOMM Incorporated, San Diego, CA (US)

(72) Inventors: Sambit BEHURA, Hyderabad (IN); Nazmul ISLAM, Littleton, MA (US); Varun WALIA, Hyderabad (IN); Ishdeep Singh JUNEJA, Hyderabad (IN)

(21) Appl. No.: 18/646,509

(22) Filed: Apr. 25, 2024

(51) Int. Cl. H04W 68/02; H04W 72/23

(52) U.S. Cl. CPC H04W 68/02; H04W 72/23

(57) ABSTRACT

A method for wireless communication at a user equipment (UE) includes receiving a paging early indicator (PEI) downlink control information (DCI) message indicating a number of paging occasions for monitoring by UE subgroups. The method also includes receiving a feature mapping DCI message including a mapping between a feature list and each paging occasion indicated in the PEI DCI message. The method further includes monitoring a paging occasion indicated in the PEI DCI message in response to the UE supporting a feature mapped to the paging occasion and in response to the UE belonging to a UE subgroup associated with the paging occasion.

### FIELD OF THE DISCLOSURE

The present disclosure relates generally to wireless communications, and more specifically to enhanced paging early indication (PEI) messaging for user equipment (UEs), including feature list mapping for paging occasions post-PEI.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a fifth generation (5G) Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method for wireless communication at a user equipment (UE) includes receiving a paging early indicator (PEI) downlink control information (DCI) message indicating a number of paging occasions for monitoring by UE subgroups. The method also includes receiving a feature mapping DCI message including a mapping between a feature list and each paging occasion indicated in the PEI DCI message. The method further includes monitoring a paging occasion indicated in the PEI DCI message in response to the UE supporting a feature mapped to the paging occasion and in response to the UE belonging to a UE subgroup associated with the paging occasion.

In other aspects of the present disclosure, a method of wireless communication at a network device includes transmitting a paging early indicator (PEI) downlink control information (DCI) message indicating a number of paging occasions for monitoring by user equipment (UE) subgroups. The method also includes transmitting a feature mapping DCI message including a mapping between a feature list and each paging occasion indicated in the PEI DCI message, after transmitting the PEI DCI message.

Other aspects of the present disclosure are directed to an apparatus. The apparatus has at least one memory and one or more processors coupled to the at least one memory. The processor(s) is configured to receive a paging early indicator (PEI) downlink control information (DCI) message indicating a number of paging occasions for monitoring by UE subgroups. The processor(s) is also configured to receive a feature mapping DCI message including a mapping between a feature list and each paging occasion indicated in the PEI DCI message. The processor(s) is further configured to monitor a paging occasion indicated in the PEI DCI message in response to the UE supporting a feature mapped to the paging occasion and in response to the UE belonging to a UE subgroup associated with the paging occasion.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a timeline illustrating paging early indication (PEI) processing.

FIG. 5A is a diagram illustrating a legacy system information block (SIB).

FIG. 5B is a diagram illustrating feature specific and non-feature specific messaging for feature UEs and non-feature UEs.

FIG. 6 is a diagram illustrating network-side and UE-side processing for paging early indication (PEI) with feature mapping for paging occasions, in accordance with various aspects of the present disclosure.

FIG. 7 is a diagram illustrating radio resource control (RRC) information elements (IEs) for paging early indication (PEI) with feature mapping for paging occasions, in accordance with various aspects of the present disclosure.

FIG. 8 is a diagram illustrating a bit structure for a paging early indication (PEI) downlink control information (DCI) message, in accordance with various aspects of the present disclosure.

FIG. 9 is a diagram illustrating a bit structure for a feature mapping downlink control information (DCI) message, in accordance with various aspects of the present disclosure.

FIG. 10 is a timeline illustrating monitoring occasions for the feature mapping DCI message illustrated in FIG. 9, in accordance with various aspects of the present disclosure.

FIG. 11 is a timing diagram comparing legacy UE paging early indication (PEI) based paging occasion monitoring with feature mapping PEI, in accordance with various aspects of the present disclosure.

FIG. 12 is a flow diagram illustrating an example process performed, for example, by a user equipment (UE), in accordance with various aspects of the present disclosure.

FIG. 13 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with fifth generation (5G) and later wireless technologies, aspects of the present disclosure can be applied in other generation-based communications systems, such as and including third generation (3G) and/or fourth generation (4G) technologies.

The concepts of paging-subgrouping of user equipment (UEs) and paging early indication (PEI) have been introduced, along with the concept of feature UEs. Feature UEs support special features, such as reduced capability (RedCap), enhanced RedCap (e-RedCap), small data transmission (SDT), network slice access stratum (AS) group (NSAG), non-terrestrial network (NTN), etc. Sixth generation (6G) networks are expected to retain these concepts of PEI and classification of feature UEs vs. non-feature UEs, while also expanding upon the list of novel features that would address new real world use cases. With the emergence of feature UEs, a given paging subgroup can consist of a mix of different types of feature UEs and non-feature UEs. In accordance with legacy PEI procedures, if the UE detects a PEI and the PEI indicates the subgroup that the UE belongs to for monitoring its associated paging occasion (PO), only then does the UE monitor the associated PO. PEI operates as a filtering method for POs associated with a UE that are to be monitored.

In future deployments, such as with 6G networks, when the network has prior knowledge that a paging context generated in the network buffer for an upcoming paging occasion that is enabled via PEI is applicable only to particular types of feature UEs, then it would be beneficial if the network could map the given PO to the applicable features list. This mapping can be conveyed to the UEs after a PEI message, and thus, only the applicable types of UEs would need to monitor their associated PO, rather than all types of associated UEs waking up for PO monitoring. This process would act as a second layer of filtering of POs on top of legacy PEI, thereby enhancing further network deployments, such as 6G and beyond. Aspects of the present disclosure relate to a few use cases and the solutions for feature list mapping for paging occasions via a modified downlink control information message payload, such as a format 2_7 downlink control information (DCI) message (DCI_2_7) payload, after a PEI message.

According to aspects of the present disclosure, a PO to feature list mapping is generated prior to the transmission of a short message for system information updating. The mapping associates a PEI enabled PO to a list of applicable features, for which the system information modification context is applicable. The same mapping may be conveyed to the UEs after the PEI. Accordingly, only a subset of the feature UEs, as indicated in the mapping, wake up to monitor their associated POs. The remaining types of UEs can choose to ignore the PEI and continue deep sleep.

According to further aspects of the present disclosure, the network stores the feature capability context of each UE, both idle and inactive, for each subgroup. The network may then understand the feature distribution across the UEs, in other words, which UEs map to which features. Accordingly, the network may generate a UE identity to feature capability mapping of all registered UEs. Further, the network may intelligently filter out UE identities in a paging record list against feature types for the paging message present in the network buffer. The network may generate a PO to feature list mapping that associates a PO to a list of applicable features for which the paging message context is valid, prior to the transmission of the paging message. The same mapping may be conveyed to the UEs just after the PEI DCI message. Then, only a subset of the feature UEs, as indicated in the mapping, wake up to monitor their associated POs to decode the paging message. The remaining types of UEs can ignore the PEI and continue deep sleep.

Particular aspects of the subject matter described in this disclosure can be implemented to realize one or more of the following potential advantages. In some examples, the described techniques, such as enhanced PEI with feature mapping for paging occasions may reduce UE power consumption by preventing unnecessary wakeups from sleep mode.

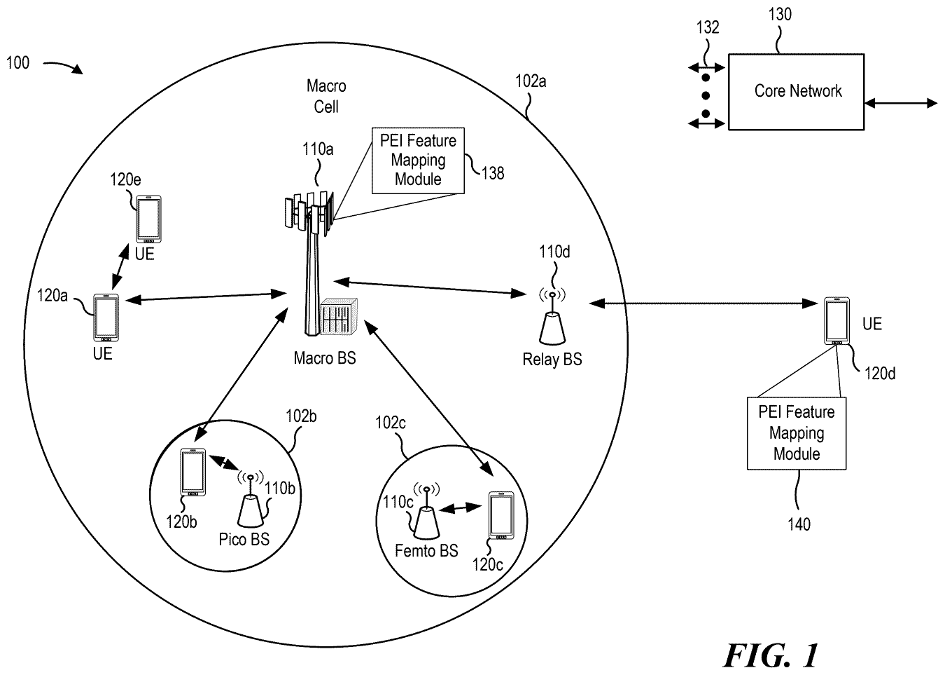

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a paging early indication (PEI) feature mapping module 140. For brevity, only one UE 120d is shown as including the PEI feature mapping module 140. The PEI feature mapping module 140 may receive a paging early indicator (PEI) downlink control information (DCI) message indicating a number of paging occasions for monitoring by UE. The PEI feature mapping module 140 may also receive a feature mapping DCI message including a mapping between a feature list and each paging occasion indicated in the PEI DCI message. The PEI feature mapping module 140 may further monitor a paging occasion indicated in the PEI DCI message in response to the UE supporting a feature mapped to the paging occasion and in response to the UE belonging to a UE subgroup associated with the paging occasion.

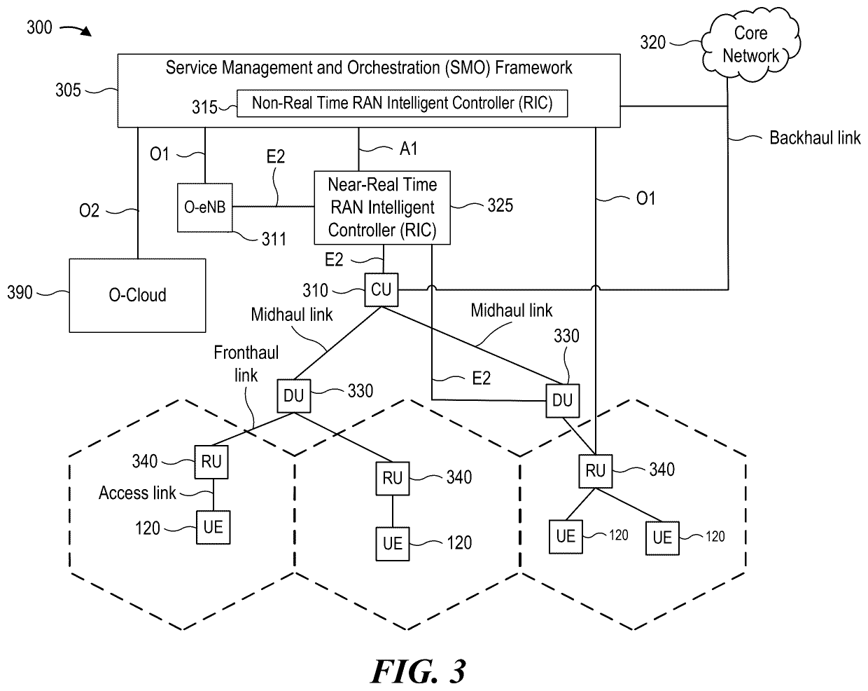

The core network 130 or the base stations 110 or any other network device (e.g., as seen in FIG. 3) may include a PEI feature mapping module 138. For brevity, only one base station 110 is shown as including the PEI feature mapping module 138. The PEI feature mapping module 138 may transmit a paging early indicator (PEI) downlink control information (DCI) message indicating a number of paging occasions for monitoring by user equipment (UE) subgroups. The PEI feature mapping module 138 may also transmit a feature mapping DCI message including a mapping between a feature list and each paging occasion indicated in the PEI DCI message, after transmitting the PEI DCI message.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

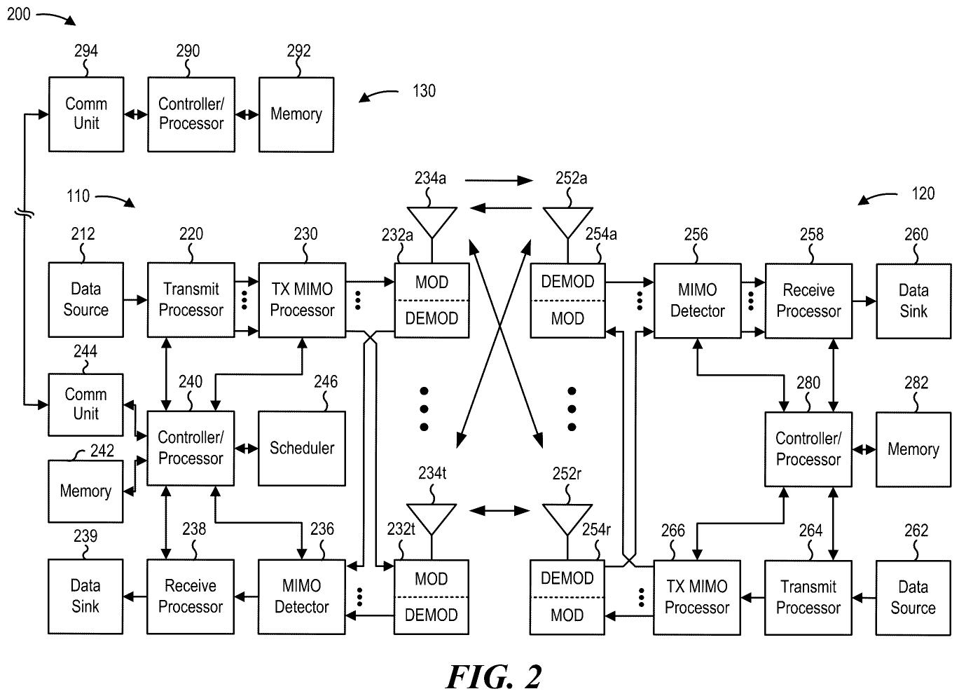

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

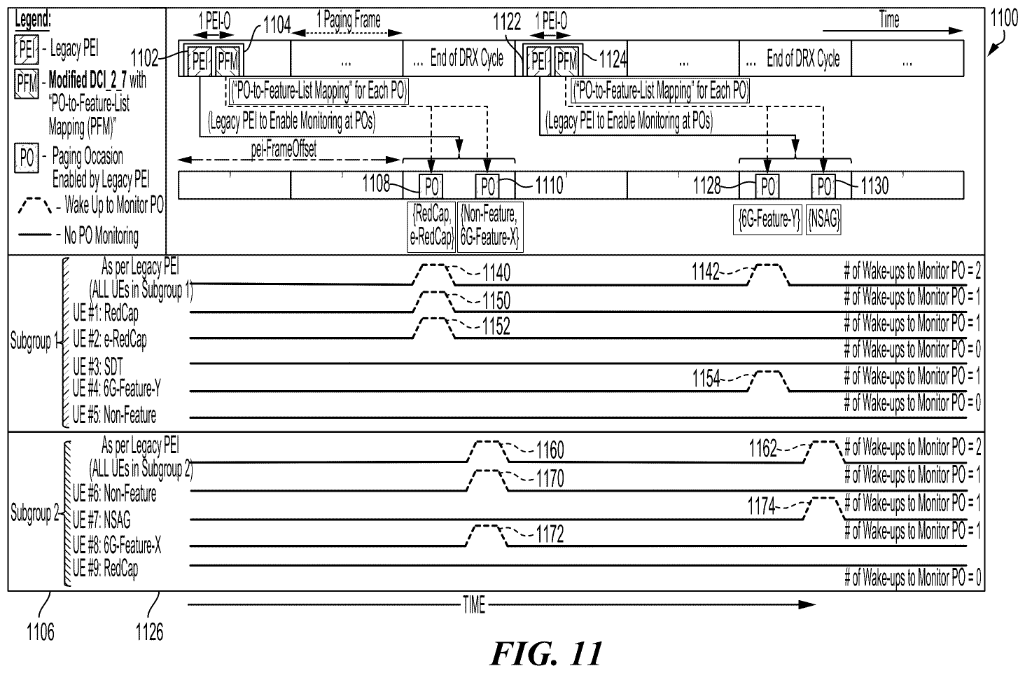

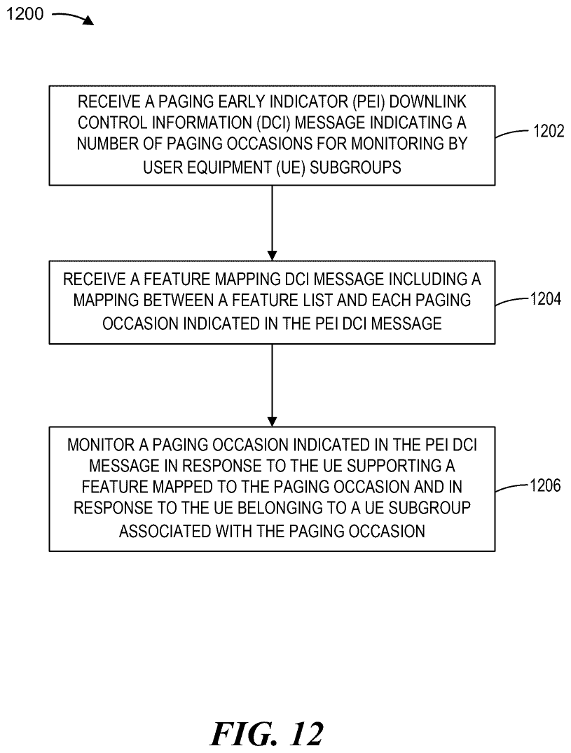

The controller/processor 240 of the base station 110, the controller/processor 280 of the UE 120, and/or any other component(s) of FIG. 2 may perform one or more techniques associated with PEI with feature mapping for paging occasion, as described in more detail elsewhere. For example, the controller/processor 240 of the base station 110, the controller/processor 280 of the UE 120, and/or any other component(s) of FIG. 2 may perform or direct operations of, for example, the processes of FIGS. 11 and 12 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for monitoring, means for skipping monitoring, means for transmitting, means for determining, means for identifying, means for populating, means for storing, means for generating, means for updating, and means for scrambling. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit—user plane (CU-UP)), control plane functionality (e.g., central unit—control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an AI interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via 01) or via creation of RAN management policies (such as A1 policies).

The concepts of paging-subgrouping of user equipment (UEs) and paging early indication (PEI) have been introduced, along with the concept of feature UEs. Feature UEs support special features, such as reduced capability (RedCap), enhanced RedCap (e-RedCap), small data transmission (SDT), network slice access stratum (AS) group (NSAG), non-terrestrial network (NTN), etc. Sixth generation (6G) networks are expected to retain these concepts of PEI and classification of feature UEs vs. non-feature UEs, while also expanding upon the list of novel features that would address new real world use cases. With the emergence of feature UEs, a given paging subgroup can consist of a mix of different types of feature UEs and non-feature UEs. In accordance with legacy PEI procedures, if the UE detects a PEI and the PEI indicates the subgroup that the UE belongs for monitoring its associated paging occasion (PO), only then does the UE monitor the associated PO. PEI operates as a filtering method for POs associated with a UE that are to be monitored.

In future deployments, such as with 6G networks, when the network has prior knowledge that a paging context generated in the network buffer for an upcoming paging occasion that is enabled via PEI is applicable only to particular types of feature UEs, then it would be beneficial if the network could map the given PO to the applicable features list. This mapping can be conveyed to the UEs after a PEI message, and thus, only the applicable types of UEs would need to monitor their associated PO, rather than all types of associated UEs waking up for PO monitoring. This process would act as a second layer of filtering of POs on top of legacy PEI, thereby enhancing further network deployments, such as 6G and beyond. Aspects of the present disclosure relate to a few use cases and the solutions for feature list mapping for paging occasions via a modified downlink control information message payload, such as a format 2_7 downlink control information (DCI) message (DCI_2_7) payload, after a PEI message.

The legacy PEI procedure will now be discussed. Paging early indication (PEI) can signal the presence of a paging message for associated paging occasions (POs). A UE supporting PEI monitors one PEI occasion for every idle mode discontinuous reception (IDRX) cycle. A PEI occasion is a set of S*X consecutive physical downlink control channel (PDCCH) monitoring occasions, where S represents the number of actual transmitted synchronization signal blocks (SSBs) determined according to the information element ssb-PositionsInBurst in system information block one (SIB1), and X represents the number of PDCCH monitoring occasions per SSB in a paging occasion (nrofPDCCH-MonitoringOccassionPerSSB-InPO), if configured. Otherwise, X is equal to one. The PDCCH monitoring occasions for PEI are determined according to the parameter pei-SearchSpace, pei-FrameOffset, firstPDCCH-MonitoringOccasionOfPEI-O, and nrofPDCCH-MonitoringOccasionPerSSB-InPO, if configured.

When the UE detects a PEI within its paging early indication occasion (PEI-O), the UE is not required to monitor the subsequent monitoring occasion(s) associated with the same PEI-O. If the UE detects a PEI and the PEI indicates the subgroup the UE belongs to for monitoring its associated PO, the UE monitors the associated PO. If the UE does not detect a PEI on the monitored PEI occasion or the PEI does not indicate the subgroup the UE belongs to for monitoring its associated PO, the UE is not required to monitor the associated PO.

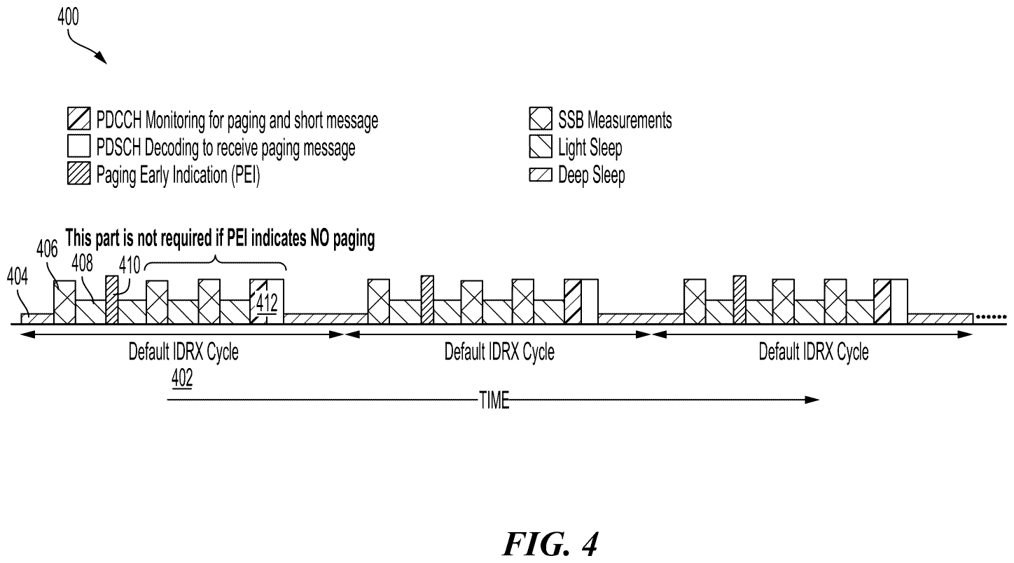

FIG. 4 is a timeline 400 illustrating paging early indication (PEI) processing. In the example of FIG. 4, three idle mode DRX (IDRX) cycles are shown. Only a first IDRX cycle 402 will be described in detail, as the other cycles are similar. In the first IDRX cycle 402, after a deep sleep period 404, the UE awakens and performs SSB measurements 406 before the UE enters a light sleep period 408. Upon waking from the light sleep period 408, a paging early indication (PEI) message 410 arrives, informing the UE as to whether the UE should monitor a later paging occasion (PO) 412. If the UE detects the PEI message 410 and the PEI message 410 indicates the subgroup the UE belongs to for monitoring its associated PO 412, the UE monitors the associated PO 412. The later PO 412 includes both a DCI message received on a PDCCH and the corresponding physical downlink shared channel (PDSCH) to be decoded for receiving a paging message.

The legacy downlink control information (DCI) format 2_7 (DCI 2_7)message structure will now be discussed. For DCI 2_7, the maximum message size is 41 bits for licensed spectrum, and 43 bits for unlicensed spectrum. The number of paging occasions per PEI (M) (po-NumPerPEI) may be equal to one, two, four, or eight. The number of subgroups per paging occasion (L) is less than or equal to eight. A tracking reference signal (TRS) indication is between zero and six bits. The information element (IE) payloadSizeDci-2-7 indicates a total size of the DCI 2-7 payload.

Legacy paging subgroups and PO determination will now be discussed. If PEI and subgrouping are both configured, UEs monitoring the same PO can be divided into one or more subgroups. With subgrouping, the UE monitors a PO if the corresponding bit for the subgroup to which the UE belongs to is indicated as one in the PEI corresponding to the PO. A UE subgroup can either be assigned by the core network or be formed based on the UE identity (ID). Currently, the UE monitors one paging occasion (PO) per discontinuous reception (DRX) cycle. The paging frame (PF) and PO for paging are determined by the following formulae:

System frame number (SFN) for the paging frame (PF) is determined by: (SFN+PF_offset) mod T=(T div N)*(UE_ID mod N); and Index (i_s), indicating the index of the PO is determined by: i_s=floor (UE_ID/N) mod Ns, where SFN represents the system frame number, N represents the number of total paging frames in T, T represents the DRX cycle of the UE, Ns represents the number of paging occasions for a PF, PF_offset represents the offset used for PF determination, and UE_ID is a serving-temporary mobile subscriber identity (S-TMSI) mod 4096 if the UE operates in extended discontinuous reception mode (eDRX), otherwise TMSI mod 1024.

If the UE detects a PEI and the PEI indicates the subgroup the UE belongs to for monitoring its associated PO, the UE monitors the associated PO.

A first use case will now be discussed. The first use case is directed to paging intended to convey only a short message for system information modification. When PEI is configured for this use case, the base station (e.g., gNB) first transmits a PEI message to enable or instruct UEs to monitor their associated POs that are supposed to carry the DCI format 1_0 message for the short message.

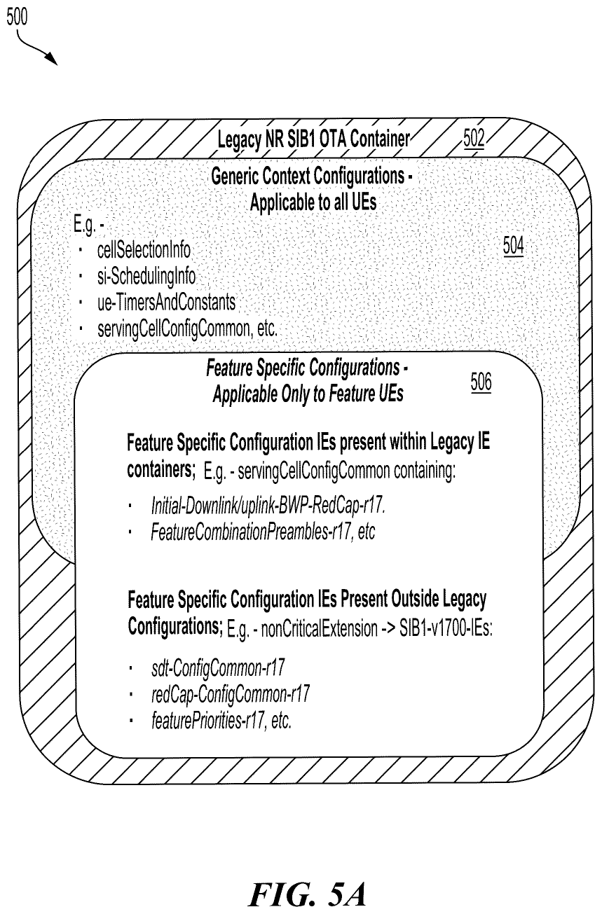

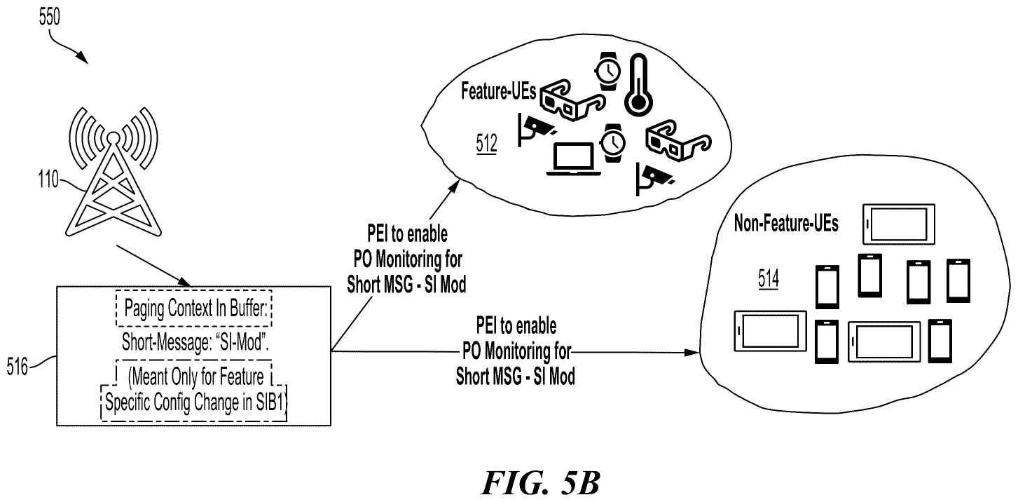

FIG. 5A is a diagram 500 illustrating a legacy system information block. As shown in FIG. 5A, a new radio (NR) system information block one (SIB1) over the air (OTA) container 502 includes a generic or legacy context configuration 504, which is applicable to both feature UEs and non-feature UEs. The NR SIB1 OTA container 502 also includes a feature specific configuration 506, which is applicable only to feature UEs, such as RedCap UEs, e-RedCap UEs, SDT UEs, etc.

To update the feature-specific information elements (IEs) or configuration in SIB1, the base station performs a SIB1 update by transmitting a system information modification short message on one or more applicable POs, addressed to all types of registered UEs monitoring those POs.

FIG. 5B is a diagram 550 illustrating feature specific and non-feature specific messaging for feature UEs 512 and non-feature UEs 514. In the example of FIG. 5B, both the feature UEs 512 and non-feature UEs 514 receive a short message for system information modification (SI-Mod) 516, even though the message from the base station 110 may only be intended for the feature UEs 512. That is, a modification of feature specific information elements (IEs) or configuration in the updated SIB1 may only be applicable to a particular list of feature UEs 512. In accordance with legacy PEI procedures, when a PO is enabled for monitoring, all of the types of UEs sharing a particular PO are instructed to wake up to monitor the PO for the short message. This procedure leads to unnecessary idle mode activity and wakeups for the other feature UEs 512 and non-feature UEs 514 for whom the context of this system information modification may not be applicable.

According to aspects of the present disclosure, a PO to feature list mapping is generated prior to the transmission of the short message. The mapping associates a PEI enabled PO to a list of applicable features, for which the system information modification context is applicable. The same mapping may be conveyed to the UEs after the PEI. Accordingly, only a subset of the feature UEs, as indicated in the mapping, wake up to monitor their associated POs. The remaining types of UEs can choose to ignore the PEI and continue deep sleep.

A second use case is directed to paging intended to convey a paging message for triggering radio resource control (RRC) connection setup or resume request for applicable idle or inactive UEs. The paging message may initiate an incoming call or an incoming data session. Only UEs mentioned in the paging message are to wake up. In this scenario, when PEI is configured, the base station first transmits a PEI to enable or instruct UEs to monitor their associated POs, that carry the DCI format 1_0 message to schedule the paging PDSCH. A paging over the air (OTA) RRC message instructs a UE to take required action only if any one of the UE identities included in any of the paging records (e.g., RRC IE: Paging, PagingRecordList, PagingRecord, and UE-Identity) matches its own UE identity allocated by upper layers. Currently, the network stores the feature capability context for all inactive UEs, tagged to UE identity. The network does not currently store the feature capability context for idle UEs.

In some cases, a paging message may not have any valid context for certain types of feature UEs or non-feature UEs. When the network has prior knowledge of the paging record list of the paging message in the buffer and if the feature capabilities of all the registered UEs, both idle and inactive, are known (e.g., UE identity to feature capability mapping is known), the network may then filter out the UE identities per feature type. If the UE identities present in paging records do not match certain features, the network may only select types of feature UEs, per subgroup, to receive this paging message. For example, there may be small data transmission (SDT) UEs in a subgroup along with other feature UEs or non-feature UEs. Because SDT UEs may not need to transition to connected mode very often, the paging messages scheduled on their associated POs may often not have their UE identities in the paging records. The paging messages may mostly be relevant for other types of UEs monitoring the same POs. For legacy PEI procedures, when a PO is enabled for monitoring, all the types of UEs sharing a particular PO are instructed to wake up to monitor the PO for the DCI scheduling the paging message.

Also, because current networks do not store the feature capability context for idle UEs, the network may have difficulty determining the feature distribution across the UEs in a given subgroup. Thus, the UE identity to feature capability mapping cannot be generated at the network. This limitation leads to unnecessary idle mode activity and wakeups for the other feature UEs or non-feature UEs for whom the context of this paging message may not be applicable.

According to aspects of the present disclosure, the network stores the feature capability context of each UE, both idle and inactive, for each subgroup. The network may then understand the feature distribution across the UEs, in other words, which UEs map to which features. Accordingly, the network may generate a UE identity to feature capability mapping of all registered UEs. Further, the network may intelligently filter out UE identities in the paging record list against feature types for the paging message present in the network buffer. The network may generate a PO to feature list mapping that associates a PO to a list of applicable features for which the paging message context is valid, prior to the transmission of the paging message.

The same mapping may be conveyed to the UEs just after the PEI DCI message. Then, only a subset of the feature UEs, as indicated in the mapping, wake up to monitor their associated POs to decode the paging message. The remaining types of UEs can ignore the PEI and continue deep sleep.

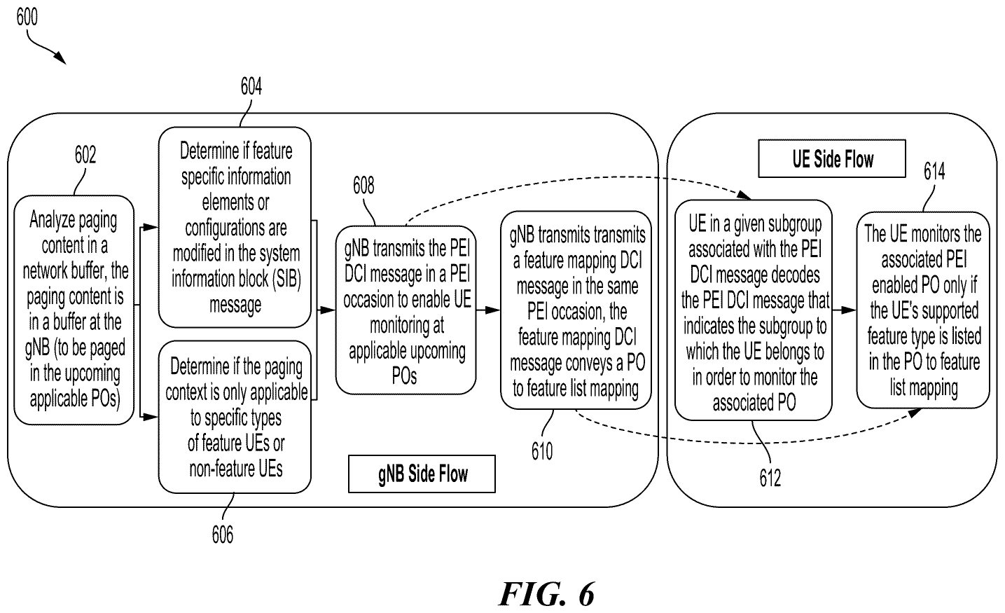

A feature list mapping for paging occasions after transmitting the PEI DCI message is now described with respect to FIG. 6. FIG. 6 is a diagram 600 illustrating network-side and UE-side processing for paging early indication (PEI) with feature mapping for paging occasions, in accordance with various aspects of the present disclosure. After transmission of the PEI DCI message (e.g., via the legacy DCI 2_7 format payload), which enables monitoring on certain POs, a network may subsequently transmit another modified DCI_2_7 format payload that can carry the PO to feature list mapping corresponding to all the POs indicated in the previous PEI DCI message.

Thus, the network (e.g., gNB) analyzes paging content in a network buffer at block 602. The paging content to be analyzed is for UEs to be paged in upcoming POs. The network then determines if the paging content corresponds to a short message with system information modifications. If so, at block 604, the network also determines if feature specific information elements or configurations are modified in the system information block (SIB) message. If the paging content is a paging message, at block the 606, the network determines if the paging context is only applicable to specific types of feature UEs or non-feature UEs. When the determinations at blocks 604 or 606 are in the affirmative, the network transmits the PEI DCI message (also referred to as a legacy PEI) in a PEI occasion to enable UE monitoring at applicable upcoming POs, at block 608. At block 610, the network transmits a feature mapping DCI message (also referred to as a modified DCI format 2_7 message) in the same PEI occasion. The feature mapping DCI message conveys a PO to feature list mapping.

A UE, for which PO monitoring is enabled via the PEI DCI message, interprets the PO to feature list mapping for the associated PO based on decoding the subsequent transmission of the feature mapping DCI message. More specifically, at block 612, the UE in a given subgroup associated with the PEI DCI message decodes the PEI DCI message that indicates the subgroup to which the UE belongs to in order to monitor the associated PO. At block 614, this UE monitors the associated PEI enabled PO only if the UE's supported feature type is listed in the PO to feature list mapping. Otherwise, the UE assumes that the context of the upcoming paging message or short-message is not applicable to the feature type of the UE, the UE ignores the previous PEI, and enters sleep mode after decoding the feature mapping DCI message payload.

This procedure, as shown in FIG. 6, operates as an enhancement, e.g., a second layer of filtering, on top of legacy PEI processing, for which POs are to be monitored based on applicable feature lists. One reserved bit in the legacy structure of DCI format 2_7 message may indicate whether a given payload carries the legacy PEI or the proposed PO to feature list mapping. When the DCI format 2_7 payload conveys the PO to feature list mapping, the DCI message has a modified payload bit structure, with each message's cyclic redundancy check (CRC) codes scrambled with a same PEI radio network temporary identifier (RNTI). After PEI transmission, in some aspects, the subsequent transmission of the feature mapping DCI message occurs within the same PEI occasion as the PEI, but in one of the subsequent PDCCH monitoring occasions of the synchronization signal block (SSB).

Network-side processing will now be described in further detail, including mechanisms and rules for generating the PO to feature list mapping for each PO at the network by analyzing the paging message present in the network buffer.

When paging is for a short message with system information modification, the network analyzes the paging message to determine the modifications or updates needed in the SIB1 RRC container. If modifications are only to feature specific information elements or configurations, then the network identifies the applicable list of features. The network populates the applicable list of features into the PO to feature list mapping for the PO that will carry this short message.

When a PO is only for paging a physical downlink shared channel (PDSCH) or paging message, the network stores the feature capability context of all registered UEs per subgroup, both idle UEs and inactive UEs. The network then generates a UE identity to feature capability map for all UEs. The feature capability context for each UE is based on the last exchanged UE capability information. The network then analyzes the paging record list for the paging message in the buffer. For each UE identity present in the paging records, the network retrieves the stored UE identity to feature capability map and populates the applicable list of features into the PO to feature list mapping for the PO that will carry this paging message. The features not having any matching UE identities are excluded from the PO to feature list mapping.

When paging conveys both a short message for system information modification (first use case) and a paging PDSCH or paging message (second use case), the network first populates two individual interim PO to feature list mappings for each use case separately, in accordance with the individual rules described above. Then, the network takes a union of both mappings to generate the final PO to feature list mapping.

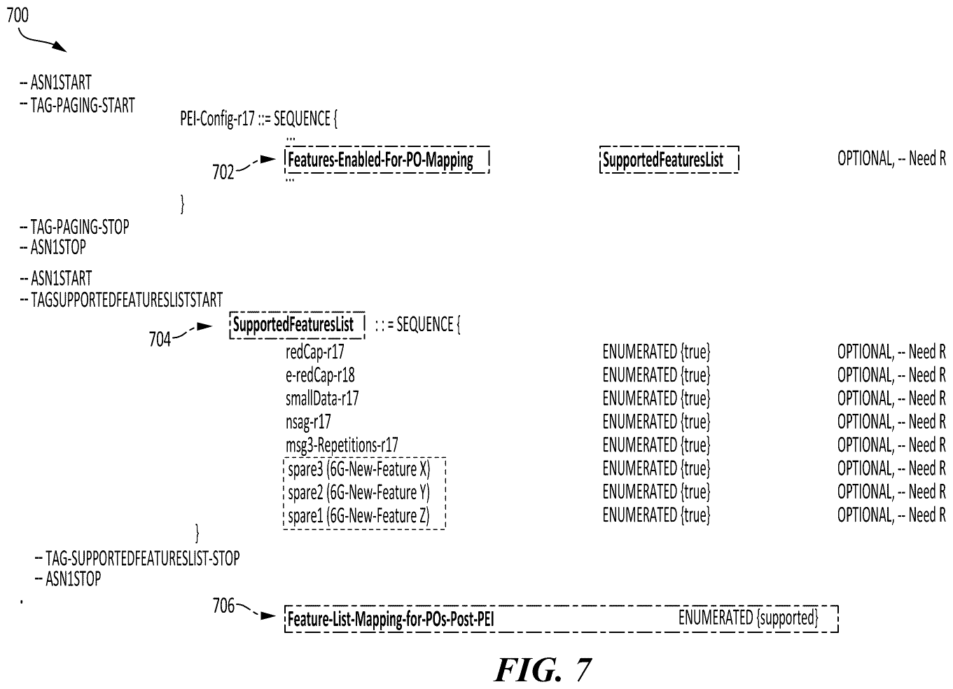

FIG. 7 is a diagram 700 illustrating radio resource control (RRC) information elements for paging early indication (PEI) with feature mapping for paging occasions, in accordance with various aspects of the present disclosure. In the example of FIG. 7, a new RRC features-enabled-for-PO-mapping information element 702 is included. The RRC features-enabled-for-PO-mapping information element 702 indicates whether a UE should monitor for a subsequent feature mapping DCI format 2_7 message. A SupportedFeaturesList information element 704 is also introduced. The network configures the SupportedFeaturesList information element 704 to indicate a list of features that are supported by the base station that shall be applicable for the PO to feature list mapping. The UE may indicate support for the new feature in a UE capability message, as seen with a new feature-list-mapping-for-POs-post-PEI information element 706.

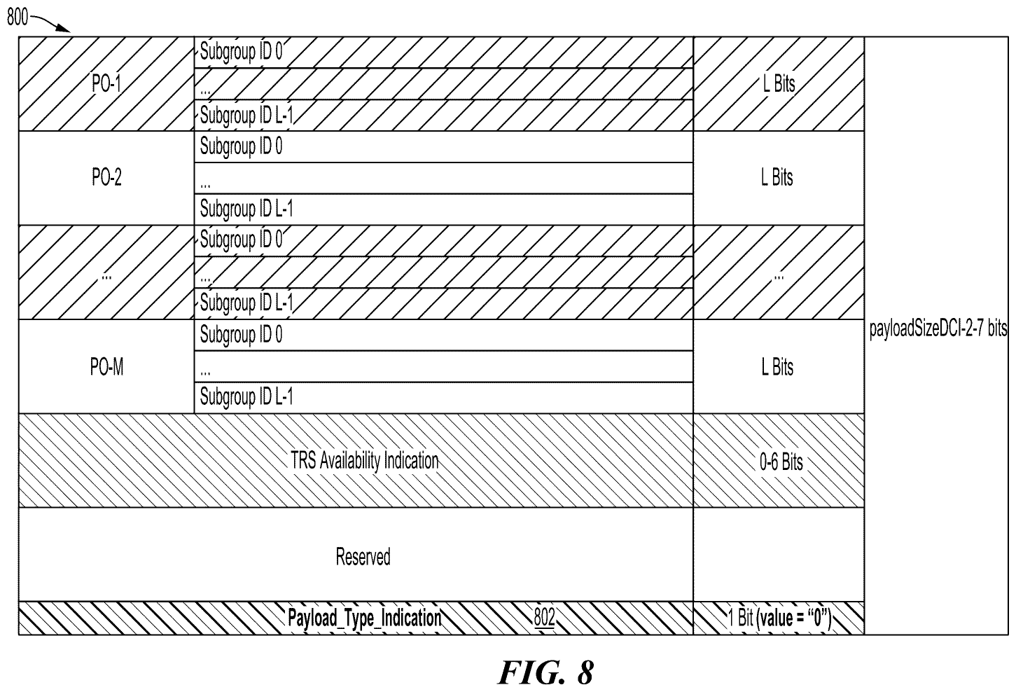

FIG. 8 is a diagram 800 illustrating a bit structure for a paging early indication (PEI) downlink control information (DCI) message, in accordance with various aspects of the present disclosure. In the example of FIG. 8, a DCI format 2_7 structure indicates a legacy PEI with a single reserved bit 802 (e.g., the Payload_Type_Indication bit). In this example, the Payload_Type_Indication bit 802 has a value of zero indicating a legacy PEI message.

A modified DCI format 2_7 payload is proposed to be transmitted immediately after the legacy PEI payload shown in FIG. 8. Monitoring occasions for this modified DCI format 2_7 are discussed later. In this modified payload, each paging occasion, configured in the previous PEI, is associated with a base station (e.g., network node) generated PO to feature list mapping.

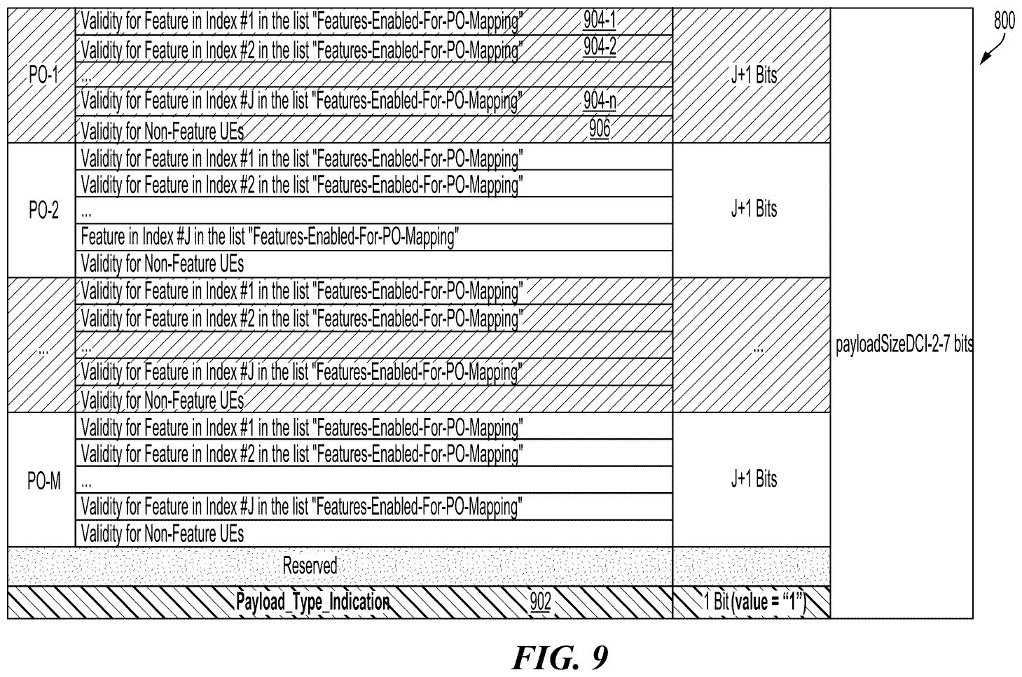

FIG. 9 is a diagram 900 illustrating a bit structure for a feature mapping downlink control information (DCI) message (also referred to as a modified DCI format 27 payload/message), in accordance with various aspects of the present disclosure. A last bit 902 of the modified DCI format 27 payload (e.g., the Payload_Type_Indication bit) indicates whether a particular DCI format 2_7 payload is for the PO to feature list mapping or is a legacy PEI. In the example of FIG. 9, the last bit 902 has a value of one, indicating the modified DCI format 27 payload. In other words, in the examples of FIGS. 8 and 9, if the Payload_Type_Indication bit 802, 902 is set to zero then that DCI 2-7 payload is for legacy PEI, otherwise, if the Payload_Type_Indication bit 802, 902 is set to one, the payload is for PO to feature list mapping.

When the modified DCI format 27 payload indicates a PO to feature list mapping, there are J+1 bits for each PO to indicate the features list enabled for that PO, where J is the length of the RRC list: PEI-Config-r17-->features-enabled-for-PO-mapping. One bit is assigned for each feature listed in the information element features-enabled-for-PO-mapping in the order of listing. In the example of FIG. 9, for PO-1, bits 904-1, 904-2, . . . 904-n are labeled. One additional bit is also assigned (e.g., the last bit per PO) for non-feature UEs. In the example of FIG. 9, for PO-1, an additional bit 906 for non-feature UEs is labeled. For each PO, when a particular bit is set to one, the bit indicates that the PO is valid, which has applicable context, for that particular feature and the UEs that support that feature should monitor the PO.

PDCCH monitoring occasions for the modified DCI format 2_7 are now discussed. As noted above, for post-PEI transmission, the subsequent transmission of the modified DCI format 2_7 payload carrying the PO to feature list mapping is expected to happen within the same PEI occasion as the PEI, but in one of the subsequent PDCCH monitoring occasions for an SSB. For legacy PEI transmissions, a PEI occasion is a set of S*X consecutive PDCCH monitoring occasions (MOs), where S is the number of actual transmitted SSBs determined according to the parameter ssbPositionsInBurst in the SIB1 transmission, and X is defined by the parameter nrofPDCCH-MonitoringOccasionPerSSB-InPO, with possible values of two, three, or four if configured or is equal to one otherwise. The RRC information element (IE): PDCCH-Config->nrofPDCCH-MonitoringOccasionPerSSB-InPO is an optional IE, only configured if the serving cell operates with shared spectrum channel access.

The [x*S+K]th PDCCH monitoring occasion for PEI in the PEI occasion (PEI-O) corresponds to the Kth transmitted SSB, where x=0, 1, . . . , X-1; and K=1, 2, . . . , S. When the UE detects a PEI within its PEI-O, the UE is not required to monitor the subsequent monitoring occasion(s) (MO(s)) associated with the same PEI-O. In multi-beam operations, the UE assumes that the same PEI is repeated in all transmitted beams.

Aspects of the present disclosure propose the following changes to the above statements to implement a feature list mapping for POs, post-PEI. For example, according to aspects of the present disclosure, the RRC IE: PDCCH-Config->nrofPDCCH-MonitoringOccasionPerSSB-InPO can be configured for non-shared spectrum channel access, as well as shared spectrum channel access, because at least two PDCCH MOs are specified within the same PEI-O.

Other changes relate to when the UE detects a PEI within its PEI-O. According to aspects of the present disclosure, the UE monitors the subsequent PDCCH MO(s) associated with the same PEI-O for the modified DCI format 27 payload carrying the PO to feature list mapping with CRC scrambled with the same PEI RNTI. The subsequent monitoring is permitted if the RRC IE ‘features-enabled-for-PO-mapping’is configured within the PEI configuration and if the UE advertises support for feature list mapping for POs, post-PEI in UE capability information.

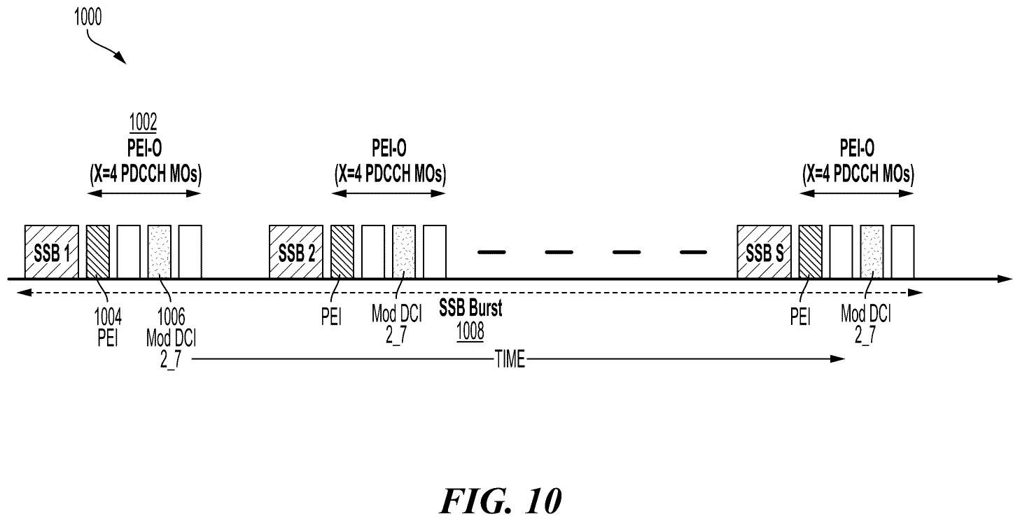

FIG. 10 is a timeline 1000 illustrating monitoring occasions for the feature mapping DCI message illustrated in FIG. 9, in accordance with various aspects of the present disclosure. A first PEI-O 1002 including the PDCCH MOs for the modified DCI format 2_7 is now described. In the example of FIG. 10, assume the parameter nrofPDCCH-MonitoringOccasionPerSSB-InPO (X)=4 and the legacy PEI (legacy DCI format 2_7 payload) is transmitted in a first PDCCH MO 1004 of the PEI-O 1002 after the first SSB (SSB1) of an SSB burst 1008 is received. The SSB burst 1008 of a DRX cycle includes S SSBs in the example of FIG. 10. Only one SSB burst 1008 is shown. After receiving the legacy PEI, the UE receives the modified DCI format 2_7 payload at a later monitoring occasion 1006.

FIG. 11 is a timing diagram 1100 comparing legacy UE paging early indication (PEI) based paging occasion monitoring with feature mapping PEI, in accordance with various aspects of the present disclosure. In the example of FIG. 11, the number of POs per paging frame (PF)=2; the pei-FrameOffset=2; the first PO in the paging frame belongs to subgroup 1, which includes five UEs, and the second PO belongs to subgroup 2, which includes four UEs. The nrofPDCCH-MonitoringOccasionPerSSB-InPO=2.

A first legacy PEI message 1102 is received, followed by a first modified DCI format 2_7 message 1104 in a first PEI-O 1106. The first modified DCI format 2_7 message 1104 indicates reduced capability and enhanced reduced capability (RedCap and e-RedCap) UEs should awaken from subgroup 1 at a first paging occasion in a first paging frame 1108. The first modified DCI format 2_7 message 1104 indicates non-feature UEs and 6G feature X UEs should awaken from subgroup 2 at a second paging occasion in the first paging frame 1110.

In a subsequent PEI-O 1126, a second legacy PEI message 1122 is received, followed by a second modified DCI format 2_7 message 1124. The second modified DCI format 2_7 message 1124 indicates 6G feature Y UEs should awaken from subgroup 1 at a first paging occasion in a second paging frame 1128. The second modified DCI format 2_7 message 1124 also indicates network slice access stratum (AS) group (NSAG) UEs should awaken from subgroup 2 at a second paging occasion in the second paging frame 1130.

There are two subgroups of UEs shown in FIG. 11, each having a mixture of different types of feature or non-feature UEs. The first subgroup (subgroup 1) includes five UEs. In subgroup 1, UE 1 is a RedCap UE, UE 2 is an e-RedCap UE, UE 3 is a small data transmission (SDT) UE, UE 4 is a 6G feature Y UE, and UE 5 is a non-feature UE. The second subgroup includes four UEs. In subgroup 2, UE 6 is a non-feature UE, UE 7 is an NSAG UE, UE 8 is a 6G feature X UE, and UE 9 is a RedCap UE.

The number of wakeups to monitor paging occasions (POs) is plotted for each UE with the techniques of the present disclosure, and for legacy PEI techniques without the benefits of the present disclosure. Without the techniques of the present disclosure, all UEs in subgroup 1 awaken to monitor the first paging occasion in the first paging frame 1108 in response to receiving the first legacy PEI message 1102, as seen at time 1140. Similarly, at time 1142 all UEs in subgroup 1 awaken to monitor the first paging occasion in the second paging frame 1128 in response to receiving the second legacy PEI message 1122. In contrast, in accordance with the techniques of the present disclosure, only UE 1 and UE 2 awaken to monitor the first paging occasion in the first paging frame 1108 in response to receiving the first legacy PEI message 1102 and first modified DCI format 2_7 message 1104, as seen at times 1150 and 1152. Only UE 4 awakens to monitor the first paging occasion in the second paging frame 1130 in response to receiving the second legacy PEI message 1122 and second modified DCI format 2_7 message 1124, as seen at time 1154.

Without the techniques of the present disclosure, all UEs in subgroup 2 awaken to monitor the second paging occasion in the first paging frame 1110 in response to receiving the first legacy PEI message 1102, as seen at time 1160. Similarly, at time 1162, all UEs in subgroup 2 awaken to monitor the second paging occasion in the second paging frame 1130 in response to receiving the second legacy PEI message 1122. In contrast, in accordance with the techniques of the present disclosure, only UE 6 and UE 8 awaken to monitor the second paging occasion in the first paging frame 1110 in response to receiving the first legacy PEI message 1102 and first modified DCI format 2_7 message 1104, as seen at times 1170 and 1172. Only UE 7 awakens to monitor the second paging occasion in the second paging frame 1130 in response to receiving the second legacy PEI message 1122 and second modified DCI format 2_7 message 1124, as seen at time 1174.

As demonstrated in the example shown in FIG. 11, the network has analyzed the context of the paging messages in its buffer and has identified the PO to feature list mapping for each upcoming PO that will be enabled by legacy PEI messaging. Hence, the network transmits the modified DCI format 27 payload carrying the PO to feature list mapping after transmission of the legacy PEI message, within the same PEI-O.

It can be seen that through the implementation of this disclosure, when the network is aware of applicability of the paging message context for each PO with regards to different feature or non-feature UEs, the network can convey the PO to feature list mapping to the UEs and that may result in fewer wakeups to monitor POs for each UE, compared to the legacy PEI mechanism. Some feature UEs or non-feature UEs do not need to monitor any of the POs when such UEs are not associated with any of the POs. For example, UE 3, UE 5, and UE 9 do not wake up to monitor any paging occasions.

As indicated above, FIGS. 3-11 are provided as examples. Other examples may differ from what is described with respect to FIGS. 3-11.

FIG. 12 is a flow diagram illustrating an example process 1200 performed, for example, by a user equipment (UE), in accordance with various aspects of the present disclosure. The example process 1200 is an example of enhanced paging early indication (PEI) messaging for user equipment (UEs), including feature list mapping for paging occasions post-PEI. The operations of the process 1200 may be implemented by a UE 120.

At block 1202, the user equipment (UE) receives a paging early indicator (PEI) downlink control information (DCI) message indicating a number of paging occasions for monitoring by UE subgroups. For example, the UE (e.g., using the antenna 252, DEMOD/MOD 254, MIMO detector 256, receive processor 258, controller/processor 280, memory 282, and/or the like) may receive the PEI DCI.

At block 1204, the user equipment (UE) receives a feature mapping DCI message including a mapping between a feature list and each paging occasion indicated in the PEI DCI message. For example, the UE (e.g., using the antenna 252, DEMOD/MOD 254, MIMO detector 256, receive processor 258, controller/processor 280, memory 282, and/or the like) may receive the feature mapping DCI message. In some aspects, the PEI DCI message and the feature mapping DCI message each have a cyclic redundancy check (CRC) code scrambled with a same PEI radio network temporary identifier (RNTI). The PEI DCI message and the feature mapping DCI message may each include a bit indicating whether a message payload corresponds to the PEI DCI message or the feature mapping DCI message. In some aspects, the UE receives the PEI DCI message and the feature mapping DCI message during a same PEI occasion in different physical downlink control channel (PDCCH) monitoring occasions per a synchronization signal block (SSB). The feature list may include an extra bit corresponding to non-featured UEs.

At block 1206, the user equipment (UE) monitors a paging occasion indicated in the PEI DCI message in response to the UE supporting a feature mapped to the paging occasion and in response to the UE belonging to a UE subgroup associated with the paging occasion. For example, the UE (e.g., using the antenna 252, DEMOD/MOD 254, MIMO detector 256, receive processor 258, TX MIMO processor 266, transmit processor 264, controller/processor 280, memory 282, and/or the like) may monitor the paging occasion. In some aspects, the UE skips monitoring of the paging occasion in response to the UE not supporting the feature mapped to the paging occasion.

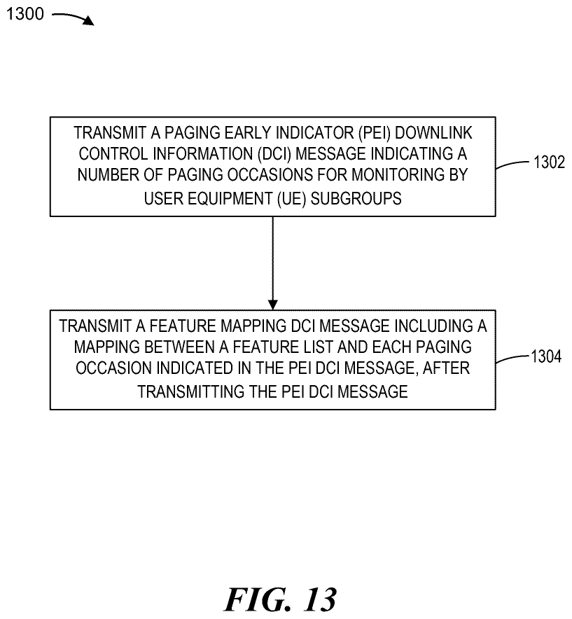

FIG. 13 is a flow diagram illustrating an example process 1300 performed, for example, by a network device, in accordance with various aspects of the present disclosure. The example process 1300 is an example of enhanced paging early indication (PEI) messaging at a network device. The operations of the process 1300 may be implemented by a base station 110.

At block 1302, the base station transmits a paging early indicator (PEI) downlink control information (DCI) message indicating a number of paging occasions for monitoring by user equipment (UE) subgroups. For example, the base station (e.g., using the antenna 234, MOD/DEMOD 232, TX MIMO processor 230, transmit processor 220, controller/processor 240, memory 242, and/or the like) may transmit the PEI DCI.

At block 1304, the base station transmits a feature mapping DCI message including a mapping between a feature list and each paging occasion indicated in the PEI DCI message, after transmitting the PEI DCI message. For example, the base station (e.g., using the antenna 234, MOD/DEMOD 232, TX MIMO processor 230, transmit processor 220, controller/processor 240, memory 242, and/or the like) may transmit the feature mapping DCI message. In some aspects, the base station scrambles a PEI DCI message cyclic redundancy check (CRC) code and a feature mapping DCI message CRC code with a same PEI radio network temporary identifier (RNTI). The PEI DCI message and the feature mapping DCI message may each include a bit indicating whether a message payload corresponds to the PEI DCI message or the feature mapping DCI message. In some aspects, the base station transmits the PEI DCI message and the feature mapping DCI message during a same PEI occasion in different physical downlink control channel (PDCCH) monitoring occasions per a synchronization signal block (SSB). The feature list may include an extra bit corresponding to non-featured UEs.

### EXAMPLE ASPECTS

Aspect 1: A method of wireless communication at a user equipment (UE), comprising: receiving a paging early indicator (PEI) downlink control information (DCI) message indicating a plurality of paging occasions for monitoring by UE subgroups; receiving a feature mapping DCI message including a mapping between a feature list and each paging occasion indicated in the PEI DCI message; and monitoring a paging occasion indicated in the PEI DCI message in response to the UE supporting a feature mapped to the paging occasion and in response to the UE belonging to a UE subgroup associated with the paging occasion.

Aspect 2: The method of Aspect 1, further comprising skipping monitoring of the paging occasion in response to the UE not supporting the feature mapped to the paging occasion.

Aspect 3: The method of Aspect 1 or 2, in which the PEI DCI message and the feature mapping DCI message each have a cyclic redundancy check (CRC) code scrambled with a same PEI radio network temporary identifier (RNTI).

Aspect 4: The method of any of the preceding Aspects, in which the PEI DCI message and the feature mapping DCI message each include a bit indicating whether a message payload corresponds to the PEI DCI message or the feature mapping DCI message.

Aspect 5: The method of any of the preceding Aspects, in which receiving the PEI DCI message and receiving the feature mapping DCI message occur during a same PEI occasion in different physical downlink control channel (PDCCH) monitoring occasions per a synchronization signal block (SSB).

Aspect 6: The method of any of the preceding Aspects, in which the feature list includes an extra bit corresponding to non-featured UEs.

Aspect 7: The method of any of the preceding Aspects, further transmitting UE capability information that indicates support of paging occasion to feature list mapping.

Aspect 8: A method of wireless communication at a network device, comprising: transmitting a paging early indicator (PEI) downlink control information (DCI) message indicating a plurality of paging occasions for monitoring by user equipment (UE) subgroups; and transmitting a feature mapping DCI message including a mapping between a feature list and each paging occasion indicated in the PEI DCI message, after transmitting the PEI DCI message.

Aspect 9: The method of Aspect 8, further comprising: determining whether modifications in a paging message for a short message for system information modification are for feature specific information elements (IEs) or configurations; identifying an applicable list of features, based on the determining; and populating the applicable list of features into the mapping between the feature list and each paging occasion indicated in the PEI DCI message that carries the short message for system modification.

Aspect 10: The method of Aspect 8 or 9, further comprising: storing a feature capability context of registered idle UEs for each subgroup and inactive UEs for each subgroup; generating a UE identity to feature capability map based on UE capability information from the idle UEs and the inactive UEs; and generating the mapping between the feature list and each paging occasion indicated in the PEI DCI message based on UE identities listed in a physical downlink shared channel (PDSCH) paging message and the UE identity to feature list.

Aspect 11: The method of any of the Aspects 8-10, further comprising: determining whether modifications in a paging message for a short message for system information modification are for feature specific information elements (IEs) or configurations; identifying an applicable list of features, based on the determining; populating the applicable list of features into the mapping between the feature list and each paging occasion indicated in the PEI DCI message that carries the short message for system modification; storing a feature capability context of registered idle UEs for each subgroup and inactive UEs for each subgroup; generating a UE identity to feature capability map based on UE capability information from the idle UEs and the inactive UEs; and updating the mapping between the feature list and each paging occasion indicated in the PEI DCI message based on UE identities listed in a physical downlink shared channel (PDSCH) paging message and the UE identity to feature list.

Aspect 12: The method of any of the Aspects 8-11, further comprising scrambling a PEI DCI message cyclic redundancy check (CRC) code and a feature mapping DCI message CRC code with a same PEI radio network temporary identifier (RNTI).

Aspect 13: The method of any of the Aspects 8-12, in which the PEI DCI message and the feature mapping DCI message each include a bit indicating whether a message payload corresponds to the PEI DCI message or the feature mapping DCI message.

Aspect 14: The method of any of the Aspects 8-13, in which transmitting the PEI DCI message and transmitting the feature mapping DCI message occur during a same PEI occasion in different physical downlink control channel (PDCCH) monitoring occasions per a synchronization signal block (SSB).

Aspect 15: The method of any of the Aspects 8-14, in which the feature list includes an extra bit corresponding to non-featured UEs.

Aspect 16: The method of any of the Aspects 8-15, further comprising receiving UE capability information that indicates support of paging occasion to feature list mapping.

Aspect 17: An apparatus for wireless communication at a user equipment (UE), comprising: at least one memory; and at least one processor coupled to the at least one memory, the at least one processor configured: to receive a paging early indicator (PEI) downlink control information (DCI) message indicating a plurality of paging occasions for monitoring by UE subgroups; to receive a feature mapping DCI message including a mapping between a feature list and each paging occasion indicated in the PEI DCI message; and to monitor a paging occasion indicated in the PEI DCI message in response to the UE supporting a feature mapped to the paging occasion and in response to the UE belonging to a UE subgroup associated with the paging occasion.

Aspect 18: The apparatus of Aspect 17, in which the at least one processor is further configured to skip monitoring of the paging occasion in response to the UE not supporting the feature mapped to the paging occasion.

Aspect 19: The apparatus of Aspect 17 or 18, in which the PEI DCI message and the feature mapping DCI message each have a cyclic redundancy check (CRC) code scrambled with a same PEI radio network temporary identifier (RNTI).

Aspect 20: The apparatus of any of the Aspects 17-19, in which the PEI DCI message and the feature mapping DCI message each include a bit indicating whether a message payload corresponds to the PEI DCI message or the feature mapping DCI message.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication at a user equipment (UE), comprising:
receiving a paging early indicator (PEI) downlink control information (DCI) message indicating a plurality of paging occasions for monitoring by UE subgroups;
receiving a feature mapping DCI message including a mapping between a feature list and each paging occasion indicated in the PEI DCI message; and
monitoring a paging occasion indicated in the PEI DCI message in response to the UE supporting a feature mapped to the paging occasion and in response to the UE belonging to a UE subgroup associated with the paging occasion.

2. The method of claim 1, further comprising skipping monitoring of the paging occasion in response to the UE not supporting the feature mapped to the paging occasion.

3. The method of claim 1, in which the PEI DCI message and the feature mapping DCI message each have a cyclic redundancy check (CRC) code scrambled with a same PEI radio network temporary identifier (RNTI).

4. The method of claim 1, in which the PEI DCI message and the feature mapping DCI message each include a bit indicating whether a message payload corresponds to the PEI DCI message or the feature mapping DCI message.

5. The method of claim 1, in which receiving the PEI DCI message and receiving the feature mapping DCI message occur during a same PEI occasion in different physical downlink control channel (PDCCH) monitoring occasions per a synchronization signal block (SSB).

6. The method of claim 1, in which the feature list includes an extra bit corresponding to non-featured UEs.

7. The method of claim 1, further transmitting UE capability information that indicates support of paging occasion to feature list mapping.

8. A method of wireless communication at a network device, comprising:
transmitting a paging early indicator (PEI) downlink control information (DCI) message indicating a plurality of paging occasions for monitoring by user equipment (UE) subgroups; and
transmitting a feature mapping DCI message including a mapping between a feature list and each paging occasion indicated in the PEI DCI message, after transmitting the PEI DCI message.

9. The method of claim 8, further comprising:
determining whether modifications in a paging message for a short message for system information modification are for feature specific information elements (IEs) or configurations;
identifying an applicable list of features, based on the determining; and
populating the applicable list of features into the mapping between the feature list and each paging occasion indicated in the PEI DCI message that carries the short message for system modification.

10. The method of claim 8, further comprising:
storing a feature capability context of registered idle UEs for each subgroup and inactive UEs for each subgroup;
generating a UE identity to feature capability map based on UE capability information from the idle UEs and the inactive UEs; and
generating the mapping between the feature list and each paging occasion indicated in the PEI DCI message based on UE identities listed in a physical downlink shared channel (PDSCH) paging message and the UE identity to feature list.

11. The method of claim 8, further comprising:
determining whether modifications in a paging message for a short message for system information modification are for feature specific information elements (IEs) or configurations;
identifying an applicable list of features, based on the determining;
populating the applicable list of features into the mapping between the feature list and each paging occasion indicated in the PEI DCI message that carries the short message for system modification;
storing a feature capability context of registered idle UEs for each subgroup and inactive UEs for each subgroup;
generating a UE identity to feature capability map based on UE capability information from the idle UEs and the inactive UEs; and
updating the mapping between the feature list and each paging occasion indicated in the PEI DCI message based on UE identities listed in a physical downlink shared channel (PDSCH) paging message and the UE identity to feature list.

12. The method of claim 8, further comprising scrambling a PEI DCI message cyclic redundancy check (CRC) code and a feature mapping DCI message CRC code with a same PEI radio network temporary identifier (RNTI).

13. The method of claim 8, in which the PEI DCI message and the feature mapping DCI message each include a bit indicating whether a message payload corresponds to the PEI DCI message or the feature mapping DCI message.

14. The method of claim 8, in which transmitting the PEI DCI message and transmitting the feature mapping DCI message occur during a same PEI occasion in different physical downlink control channel (PDCCH) monitoring occasions per a synchronization signal block (SSB).

15. The method of claim 8, in which the feature list includes an extra bit corresponding to non-featured UEs.

16. The method of claim 8, further comprising receiving UE capability information that indicates support of paging occasion to feature list mapping.

17. An apparatus for wireless communication at a user equipment (UE), comprising:
at least one memory; and
at least one processor coupled to the at least one memory, the at least one processor configured:
to receive a paging early indicator (PEI) downlink control information (DCI) message indicating a plurality of paging occasions for monitoring by UE subgroups;
to receive a feature mapping DCI message including a mapping between a feature list and each paging occasion indicated in the PEI DCI message; and
to monitor a paging occasion indicated in the PEI DCI message in response to the UE supporting a feature mapped to the paging occasion and in response to the UE belonging to a UE subgroup associated with the paging occasion.

18. The apparatus of claim 17, in which the at least one processor is further configured to skip monitoring of the paging occasion in response to the UE not supporting the feature mapped to the paging occasion.

19. The apparatus of claim 17, in which the PEI DCI message and the feature mapping DCI message each have a cyclic redundancy check (CRC) code scrambled with a same PEI radio network temporary identifier (RNTI).

20. The apparatus of claim 17, in which the PEI DCI message and the feature mapping DCI message each include a bit indicating whether a message payload corresponds to the PEI DCI message or the feature mapping DCI message.
